(19) United States
(12) Patent Application Publication
(10) Pub. No.: US 2004/0088448 A1
(43) Pub. Date: May 6, 2004

(54) Embedded system and method for controlling, monitoring of instruments or devices and processing their data via control and data protocols that can be combined or interchanged

(75) Inventors: Sanjaya N. Joshi, Kirkland, WA (US); Rajeev V. Pillai, Bangalore (IN)

Correspondence Address: Userspace Corptortion, 11118 NE 141 PL, Kirkland, WA, 98034, US

(73) Assignee: Userspace Corporation, Kirkland, WA

(21) Appl. No.: 10/272,460

(22) Filed: Oct. 16, 2002

Related U.S. Application Data
(60) Provisional application No. 60/329,629, filed on Oct. 16, 2001.

(51) Int. Cl. G06F 3/00

(52) U.S. Cl. 710/15; 709/223

(57) ABSTRACT

A system is described herein where an embedded computer method for (‘router’) is provided for full-duplex (two-way) communication between devices and TCP/IP based networking. This system uses a process development component to configure communication between the router and devices. A controller is described that can manage device functions within a single router or among a collection of routers. This controller layer can be inside the router hardware or within the data-publishing layer. Each router is connected physically to devices using physical communication ports.

This method offers significant improvements over prior art with respect to open architecture process and control protocols. The result data from the device control protocol functions are easily available for complex processes and/or inter-device communication in real time based on data decision algorithms (in various formats). This method also describes a secure distributed method of using private networks for the devices and instruments.

### BACKGROUND OF THE INVENTION

1. Technical Field

This invention relates generally to the control of and data from devices and instruments using an embedded computer device (the ‘router’) and method, and in particular relates to the usage of communication and data protocols that are selected from a list of such available protocols and their interaction for standardized algorithmic processing, storage and retrieval formats.

Current US Class: 7021183; 700/104; 702/31; 706/60; 714/26

2. Description of the Background Art

The source of data in any industry is from instrumentation, devices and humans (in the form of analysis, documentation and authorization). Instrumentation and devices are nowadays interconnected by automation platforms (for example: robots, mechanical jigs and fixtures). These ‘information generators’ produce large quantities of data in a small period of time.

As the control of these devices and instruments and their data gets more complex, a management system is needed that formats the various communications protocols to control the instrument into one or more standard control protocols and one or more standardized data protocols.

The data streaming from these instruments, ranging in complexity from binary actions by robots to large datasets per process or experiment that are output from complex instruments like Mass Spectrometers, have to be processed in real-time. Decisions are made upon this data which affect the quality and repeatability of processes which are the core of many automation efforts across industries.

These processing algorithms have to act upon the data stream in real-time and have to make control decisions in real-time as well. The formatting and storage of the data has to be available for later process use. Error management from these devices and instruments have also been proprietary. As these automation processes run in a 24/7 mode, these processes are not manned 24/7. Error notification and monitoring is a critical part of quality and repeatability of these processes. Security and connection of these processes (and their data) across diverse geographical locations has remained a challenge.

The technical staff needed to operate these instruments are either highly trained and qualified personnel who would rather be analyzing the data or personnel with sufficient qualifications that cycle through these processes making it very difficult to maintain consistency.

Owing to the above factors, the cost per transaction for these processes is usually very high till the process become highly repeatable at which point they are ready for automation. Reducing the cost per transaction early in the process is essential for saving costs, increasing throughput and quality.

U.S. Pat. Documents References:

| | | |
|---|---|---|
| 6,049,764 | April 2000 | Stahl |
| 6,233,626 | May 2001 | Swales, et al. |
| 6,173,438 | January 2001 | Kodosky, et al. |
| 6,223,134 | April 2001 | Rust, et al. |
| 6,083,276 | July 2000 | Davidson, et al. |
| 6,016,393 | January 2000 | White, et al. |
| 6,230,194 | May 2001 | Frailong, et al. |
| 6,167,448 | December 2000 | Hemphill, et al. |
| 6,223,217 | April 2001 | Pettus |
| 6,085,156 | July 2000 | Rust, et al. |
| 5,991,795 | November 1999 | Howard, et al. |
| 6,219,677 | April 2001 | Howard |
| 6,115,710 | September 2000 | White |
| 5,937,189 | August 1999 | Branson, et al. |
| 6,173,310 | January 2001 | Yost, et al. |
| 5,732,277 | April 1998 | Kodosky, et al. |
| 6,282,454 | August 2001 | Papadopoulos, et al. |
| 6,236,334 | May 2001 | Tapperson, et al. |
| 6,259,355 | July 2001 | Chaco, et al. |
| 6,266,726 | July 2001 | Nixon, et al. |
| 6,272,402 | August 2001 | Kelwaski |
| 6,205,513 | April 2001 | Godicke, et al. |

Other Publication References:

“Standard Specification for Laboratory Equipment Control Interface (LECIS)”, ASTM E1989-98

“LECIS Implementers Guide”: http://www.lecis.orq/documents/interim LECIS Implementers Guide 3.0.pdf

The DICOM Standard: http://medical.nema.orq/dicom.html

DICOM Structured Reporting, Clunie D., 2001,

http://www.dclunie.com/papers/spie mi 2001 SR manuscript.pdf

The CANbus specification: http://www.canopen.orq/downloads/specifications/?268

“A TCP/IP Tutorial”, January 1991, http://www.fags.org/rfcs/rfc1180.html

“XML-RPC Specification”, Winner, D., Jun. 15, 1999, http://www.xmlrpc.orq/spec

### BRIEF SUMMARY OF THE INVENTION

The embedded computer system and method, (also referred to as ‘bioinstrument’), allows for the controlling and monitoring of instruments, such as instruments or devices in a life science laboratory. A typical configuration of the system includes a process development component (step 102 in FIG. 1), a controller (step 103), router(s), instrument(s), and a monitor component (steps 109, 110 and 111). Each instrument is connected to a router (step 107). The routers are connected to the controller, which is in turn connected to the development component and monitor component.

The development component allows a user to define processes for controlling and monitoring the instruments. A process comprises a series of steps to be performed in sequence or in parallel. For example, a process may include the steps of loading a vile, filling the vile, reading the barcode of the vile, and unloading the vile. A process is defined in a process definition format that has an XML portion (steps 700 to 706) and a code portion.

The controller runs processes by communicating with the appropriate routers using a communications protocol, such as LECIS (FIG. 2, step 204). The controller sends commands to the routers to control the instruments as indicated by the process and receives instrument data and status information in response. The communications protocol used by a controller is installable in the sense that each instance of the system can use a communications protocol that is most appropriate to its environment. For example, LECIS may be appropriate for a life sciences lab, AUTO3P and DICOM for healthcare and CANbus or MODBUS may be appropriate for a manufacturing.

The router includes an instrument or device controller interface, a control program for each instrument, and a multiplexer. The controller interface receives commands (of the installed communications protocol) from the controller and directs the control program for the appropriate instrument to perform the command. The control program then interacts with the instrument in the protocol of the instrument. The instruments and control programs may provide information, such as status and instrument readings, to the multiplexer for sending to the controller. The multiplexer multiplexes information from multiple instruments on a single communications link to the controller.

The monitor component, which may be part of the controller, monitors the processes as they run. The monitor component may provide a graphic display of the steps of a process and display information relating to the step currently running.

The system can be categorized into three main areas:

A: Router

B: Controller and

C: User Interface.

Router

The main portion of the router is the Instrument Control Layer (FIG. 1, Step 103). The Instrument Control Layer provides a general interface to various instruments, both real and virtual (virtual instruments are instrument simulators).

This interface is accessed via Remote Procedure Calls (RPCs). Device specific commands are kept in the ICL layer as far as possible. The user-selected protocol is wrapped in an RPC dialog (see FIG. 8, step 801). Other software can use the functions accessible via RPC to control instruments and collect data. As an example, the read function in a barcode control program can be called to read barcodes instead of sending the scanner specific command. Moreover, since all barcode control programs expose a similar set of functions, the operator can read barcodes by calling read in any barcode control program for multiple barcode scanner manufacturers.

Controller

The Controller acts like a bridge between the Instrument Control Layer (ICL) and the Application Layer. It communicates through the standard TCP/IP connection encrypted using SSL (Secure Socket Layer). The Controller is described in FIG. 4.

For low-level ICL communication the controller uses Remote Procedure Calls (RPC) over standard protocols like LECIS. It parses the PRocess EMulator Interface (PREMI) file created by the ProcessManager and schedules the tasks for the process steps to ICL and controls the data coming out from the ICL using XML database for further use. Some examples are: a particular process step at execution time, error step, the raw data coming out from the devices, etc.

The Application layer is a Web Application Server (WAS) which contains the Controller layer and converts this data in various formats such as Adobe Acrobat PDF, printable format, Excel, data processing, Graph and Chart oriented, etc. The WAS can be one of many commercial or open-architecture systems.

User Interface

The User Interface is divided into the Process Manager, Monitoring and Messaging components (FIG. 2):

Process Manager Component

The Process Manager (PM), a user-friendly tool used to define a lab process, can be executed by using the ‘bioinstrument’ application. This tool is part of the ‘bioinstrument’ application.

Using this component the user can generate the Process XML in PREMI DTD (language DTD) which is understood and interpreted by the Controller in executing the lab process.

All data are in non-proprietary, cross platform and easily editable XML Format.

The advantage of this component is the ‘drag-and-drop’ user interface which shields the user creating the process from the complexities of defining a process manually. The output is the language generated which is understood, interpreted and executed by the Controller.

This tool is available as a Web-based Application and can be accessed using a web browser (with the appropriate plugin applications).

Monitoring Component

The data from the process is sent to a monitoring application.

This monitoring application can be a stand-alone web browser application or can be a feature in the Process Manager component. Both options use the Publisher layer to translate the information from the Router and/or other data sources on the customer network and package the information for the monitoring component.

Messaging Component

The messaging component allows users to monitor a lab process remotely. It runs on the server and acts as a central hub for transmission of data. This service can be enabled by selecting a few messaging icons at process creation and making it a part of the process the user needs to monitor during the process and a messaging priority that set according to the needs of the process.

Monitoring is provided to alert users instantaneously regarding the status of a process or whenever the process behaves abnormally. In these instances, the monitoring service sends the user a message providing information and requesting action if that is set in the messaging queue.

The messaging service offers alerts and monitoring by cell phone, email, paging and server logs.

By default, the information from the process is logged onto the server and does not require user intervention.

### BRIEF DESCRIPTION OF DRAWINGS

The present invention is fully understood from the description provided herein below along with the accompanying drawings, which are given by way of illustration only and are not limitive of the present invention, and wherein:

FIG. 1 describes the overall architecture of the system

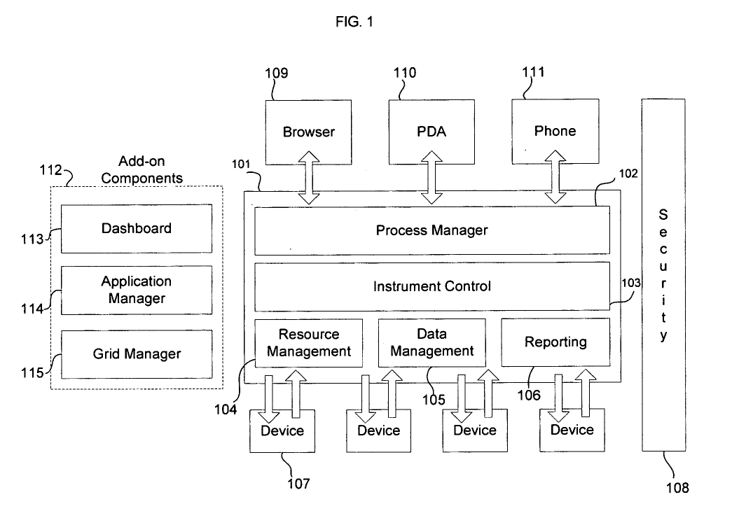

FIG. 2 explains the embedded computer (‘Router’) and the Server layers

FIG. 3 shows the high level network topology with the routers, devices/instruments and the corporate network

FIG. 4 explains the Instrument Control Layer (ICL)

FIG. 5 charts the flow of Data for the operation of the system

The series of drawings in FIG. 6 show the Process Development methodology (and router configuration) using the Process Manager tool:

FIG. 6.1: Process Navigation

FIG. 6.2: General Flow

FIG. 6.3: Add/Edit Device Class

FIG. 6.4: Add/Edit Device

FIG. 6.5: Add/Edit User

FIG. 6.6: Process creation: Step 1 (example process)

FIG. 6.7: Process design: Step 2 (example process)

FIG. 6.8: Process design: Step 3 (example process)

FIG. 7 walks through the PRocess EMulation Interface (PREMI) steps in XML, elucidating the grammar and syntax of the process using an example

FIG. 8 shows an example implementation of a process using an example standard protocol—LECIS—and Remote Procedure Calls (RPC)

FIG. 9 describes the way the Programming Language Interface is architected

FIG. 10 explains the ‘proc’ structure in the Instrument Control Layer (ICL)

### DETAILED DESCRIPTION OF THE INVENTION

(All numbers preceding with “Step” refer to the attached drawings)

Router

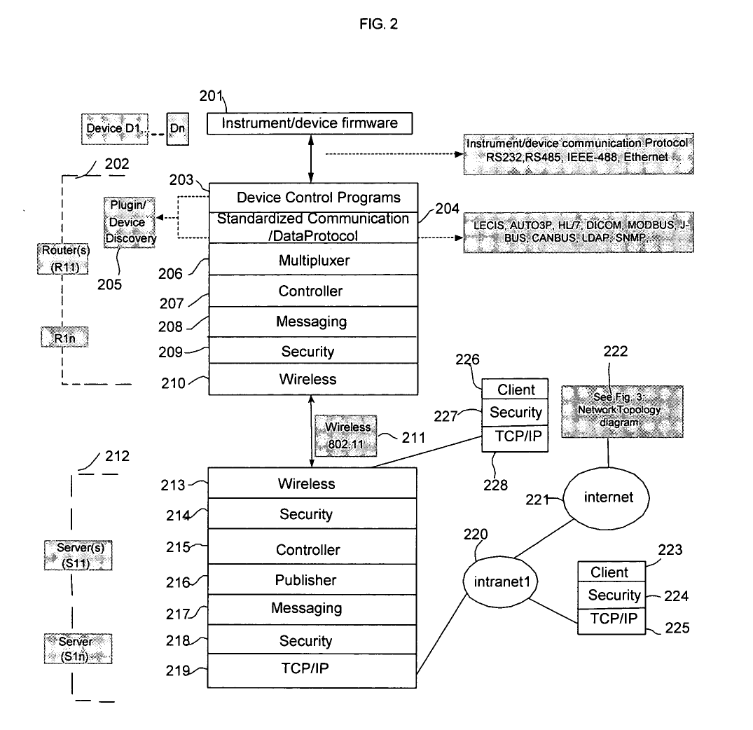

Each router is an embedded computer connected physically to many instruments or devices (described in FIG. 2, Steps 201 and 202). The router is comprised of a hardware/firmware interface comprising of:

a: Conversion of multiple instrument protocols to standard protocol (e.g., LECIS, AUTO3P) (FIG. 2, Step 204)

b: RPC architecture wherein the communication socket contains the standard protocol

c: Communications protocol between router and instruments (FIG. 2, Step 203)

d: Transportation of data from multiple instruments via one physical communication link (FIG. 2, Steps 211, 226, 227, 228)

e: Transmission data between instruments through the router using standard protocols (FIG. 2, Step 204))

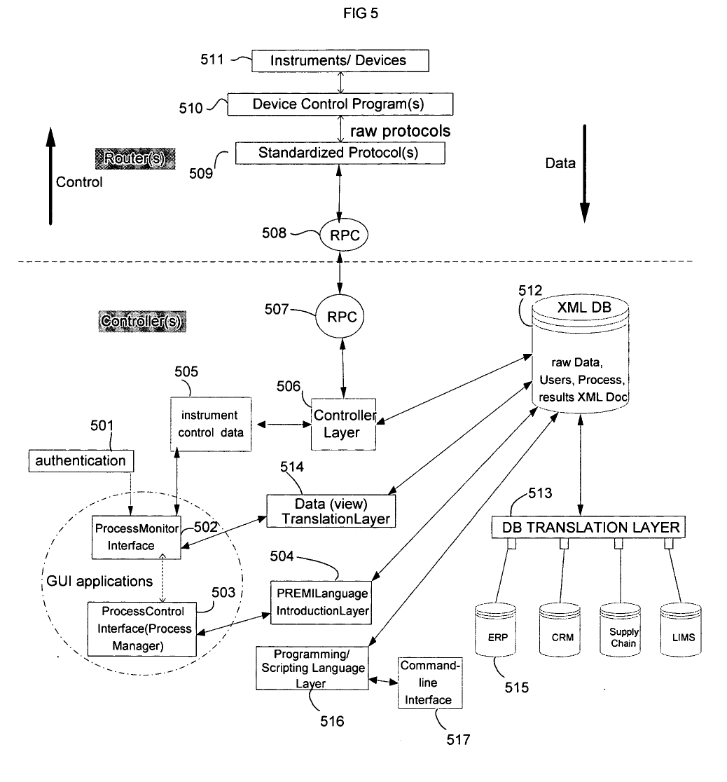

f: Post-processing of data before sending to database (FIG. 5, Step 513)

g: Process feedback to instrument (e.g., analyze process image to see if a vial is full)

Router Operation

The examples discussed in the detailed operation of the router are with respect to the LECIS protocol. Other protocols follow the same architecture.

The multiplexer is started at boot time and listens to port 1969, or another well-known port for communication between the controller and multiplexer. The controller makes a connection to the multiplexer when a process is started and keeps this connection open throughout the controller's lifetime. After connection, the controller will invoke these functions in the multiplexer:

noop(“InteractionID”)

download(“ICP”, “Host”, “Port”)

run(“ICP”, “InteractionID”)

noop( ) sets the LECIS Interacion ID that will be used for the multiplexer. The Interaction ID is used by the multiplexer to route RPC requests to the ICPs or itself. Every ICP and the multiplexer has a unique Interaction ID.

download( ) causes the multiplexer to download “ICP” by connecting to “Port” on some “Host”. This is how the ICPs are brought into the Router depending on the instruments connected to it. There is one ICP per instrument connected to the Router.

run( ) causes the multiplexer to execute an ICP. The InteractionID given is associated with an instance of a running ICP. In UNIX terms the InteractionID is used to identify each ICP process that is run by multiplexer. In run( ), a UNIX domain socket connection created to talk to the ICP and the ICP's stdin and stdout are modified so that they point to this UNIX socket connection. After run( ), the ICP will read RPC requests from its standard input and will return RPC results on standard output, both of which will point to UNIX socket that was opened by the multiplexer. This scheme was chosen so that ICPs could be written and tested independently of the multiplexer and the controller. The ICP writer can write an ICP and test it by giving RPC functions and function arguments on stdin and observing the results output to stdout.

After the ICP is verified to work correctly by itself, it can be integrated with the multiplexer without any more source code changes. All the multiplexer and the ICP have to agree upon is a common format for RPC requests and RPC results. This format used will be explained later.

After these three functions have returned successfully, RPC requests can be made to the ICPs themselves.

Router Implementation

This section will detail the implementation of the multiplexer and the RPC library, which is part of every ICP. The implementation of the ICPs themselves are instrument/device specific and is beyond the scope of this invention.

The multiplexer (‘Mux’)

The executable program for the multiplexer is called ‘mux’. It resides on the bin directory on the Router Operating System. It is either run standalone at boot time or by the inetd superserver when requests arrive at port 1969.

After it starts running, the multiplexer changes its working directory to ‘/home/[router_superuser]’ and sets its effective user ID (UID) and group ID (GID) to the user [router_superuser]. It then creates a server socket and listens for RPC requests. The RPC communication between the controller and the multiplexer takes the form of LECIS interactions sequences. As an example the following is the LECIS standard implementation which has just enough interactions to make RPC calls and receive results.

As a consequence of using LECIS interactions and semantics for RPC, the multiplexer is structured as a loop, reading and parsing LECIS interaction sequences, executing the interactions, waiting for results and sending them back. The main loop of the multiplexer looks like

if (isreadable (sockp)) {

parse (sockp, &c, v);
do_lecis (c, v);

} else {

getres ();
sndres ();

}

A LECIS interaction sequence is read and tokenized using a lex generated scanner and parsed into an argument vector by parse( ), much like the vector created by the shell for the main( ) function in any C program. The vector v [ ], and the count of arguments in the vector c, are used by do_lecis( ) to determine the interaction handler function that will be executed in the finite state machine which is run for each RPC request/response sequence.

If no interactions are waiting, any pending results will be collected by getres( ) and is sent back using sndres( ). It is written this way because RPC results from calls to ICPs can arrive asynchronously. Note that getres( ) is used to collect results from calls to ICP child processes only. RPC functions in the multiplexer are always executed synchronously. A typical interaction sequence for a RPC request to add 2 numbers using the LECIS protocol as an example is shown below:

| | |
|---|---|
| TSC: | DateTime NEXTEVENT |
| SLM: | DateTime ACK |
| TSC: | Date Time RUN_OP(“add”, “1”, “2”) |
| SLM: | DateTime ACK |
| SLM: | Date Time EventDate Time OP_STARTED |
| TSC: | DateTime ACK |
| TSC: | DateTime NEXTEVENT |
| SLM: | DateTime ACK |
| SLM: | Date Time EventDate Time OP_RESULT(“1”, “3”, “1 + 2 = 3”) |
| TSC: | DateTime ACK |
| TSC: | DateTime NEXTEVENT |
| SLM: | DateTime ACK |
| SLM: | Date Time EventDate Time OP_COMPLETED |
| TSC: | DateTime ACK |

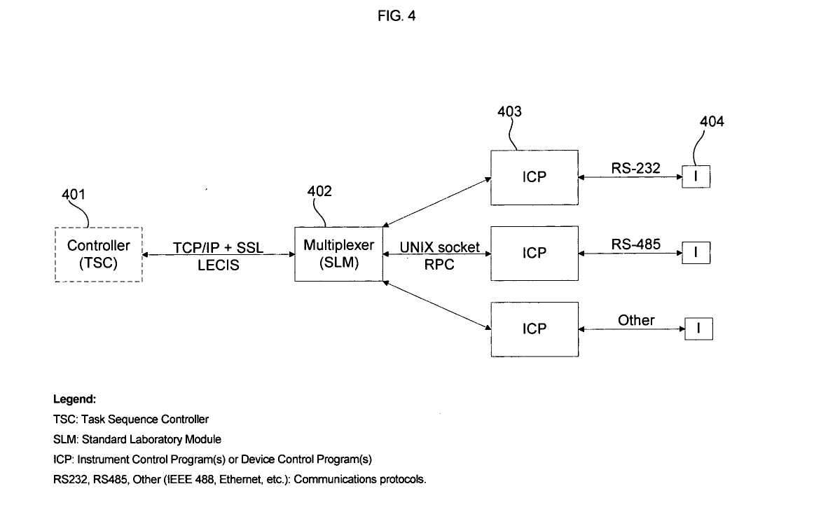

The lines marked TSC: these are LECIS interaction sequences sent by the controller (Task Sequence Controller in LECIS terminology—see FIG. 4, Step 401).

The lines marked SLM: these are the LECIS responses sent by the multiplexer (Standard Laboratory Module according to the LECIS protocol—See FIG. 4, Step 402). Note that in this implementation, the multiplexer acts like the SLM for all ICPs instead of the LECIS way, which would have been one SLM for each ICP (FIG. 4, Step 403).

DateTime is any unique number (usually the current date and time string) used to identify each LECIS interaction set.

The system, however, uses it to identify uniquely each process (ICP or multiplexer) which is the target of an RPC request. EventDateTime is the date and time at which an SLM event (results received by the multiplexer, etc) were noted.

The RPC function to be executed is the first parameter to the RUN_OP interaction sequence and the arguments to that function are the remaining parameters. The results of the RPC request are returned as an OP_RESULT interaction. The first parameter of OP_RESULT is a boolean which indicates success/failure of the RPC request. The second parameter is the raw result from the RPC call. For example, if the RPC request had been a read ( ) to a barcode ICP, the barcode value read would have been passed back here.

The third and last parameter is an informational message intended for the user, indicating why an RPC request succeeded or failed. All RPC requests generate this fixed format result.

The OP_STARTED interaction is sent after the specified RPC has been executed (synchronously) in the multiplexer or (asynchronously) dispatched to the ICPs. The OP_COMPLETED and the associated ACK interaction for it indicates the completion of a complete RPC request/response.

It is important to note that although the current implementation allows interleaving of interaction sequences to different processes as part of “parallelizing” RPC requests, it does not allow this for the same process. In other words, each RPC request/response to a particular process is considered atomic and no other RPC calls can be made until the previous one has completed. This restriction is due to the proc structure that is maintained for preserving state of each running process. This structure will be described later.

One unique feature of this embodiment is the RPC implementation for this invention is that unlike other RPC mechanisms like SUN-RPC, RMI or CORBA, no compile time stub/skeleton or interface code generation is needed for RPC to work. LECIS RPC function checking is completely at run-time and the user need not know the actual number or type of parameters within the RPC functions. Each RPC function handler will check the number and type of its arguments and generate an error on improper arguments, giving the user the opportunity to correct the RPC call and try again. For instance, in the previous example, if the add ( ) function had been given only one parameter instead of two, the RPC interaction sequence would have looked like this:

| | |
|---|---|
| TSC: | DateTime NEXTEVENT |
| SLM: | DateTime ACK |
| TSC: | DateTime RUN_OP(“add”, “1”) |
| SLM: | DateTime ACK |
| SLM: | Date Time EventDate Time OP_STARTED |
| TSC: | DateTime ACK |
| TSC: | Date Time NEXTEVENT |
| SLM: | DateTime ACK |
| SLM: | Date Time EventDate Time OP_RESULT(“0”, “Please give me 2 |
| | integers”) |
| TSC: | DateTime ACK |
| TSC: | DateTime NEXTEVENT |
| SLM: | DateTime ACK |
| SLM: | Date Time EventDate Time OP_COMPLETED |
| TSC: | DateTime ACK |

The failure of the RPC call is indicated by the FALSE (0) boolean parameter of the OP_RESULT interaction and the correct usage is presented as the third parameter. Though currently not implemented, it will be easy to add a function like list_function_help (function_name) to display the usage for function_name, to make it more user friendly.

This scheme was chosen so that a user could try out RPC calls interactively using a process editor while coding the sequence of RPC calls (steps) needed to execute a process. The intent is to have the user write down the process steps using a simple process language like:

if not barcode.read ()

display.put (“barcode read failed:” + barcode.errmsg)

else

[continue with process . . .]

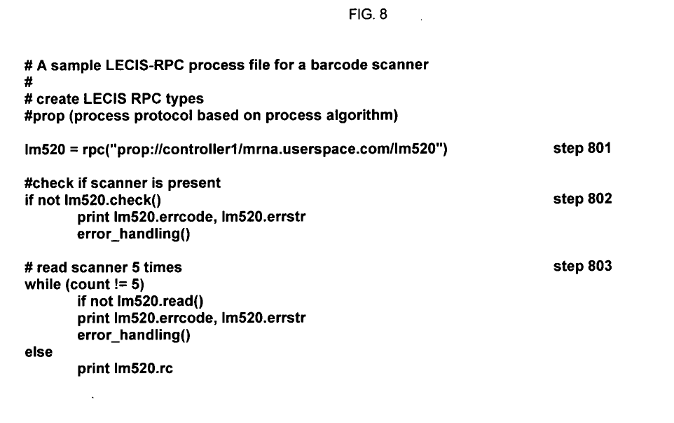

and if for example, the user was not sure of the syntax for barcode.read( ), he could type barcode. list_function_help(read) in a separate window in the process editor to see the help for read( ) before continuing with the process definition. A more detailed example is shown in FIG. 8.

The Router ‘Proc’ Structure

Since RPC requests can be interleaved between processes, quantities like the current interaction's automaton, tokens in an interaction including results of the RPC request, need to be stored on a per process basis. There is a proc structure to hold the necessary “context” until an RPC request completes.

Each process executed by the multiplexer and the multiplexer itself has a proc structure associated with it. The proc structures are chained together in a linked list with the multiplexer's proc structure forming the list head.

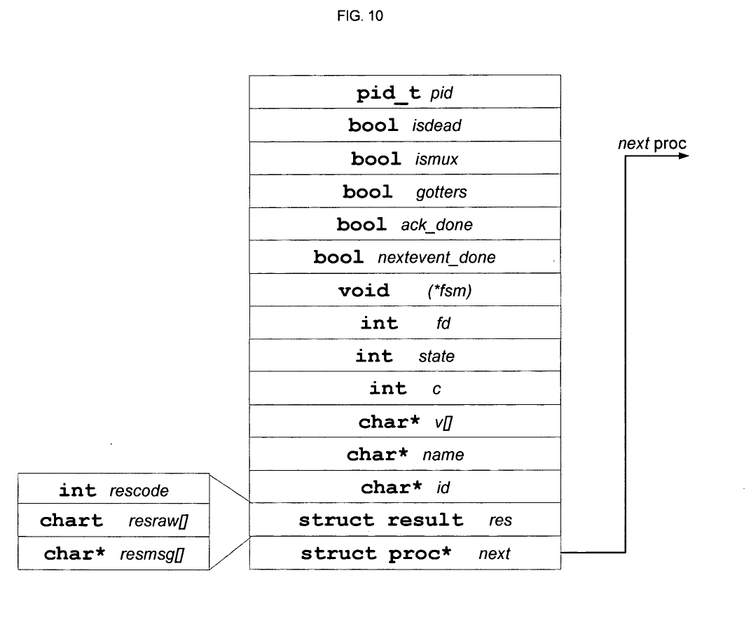

FIG. 10 shows the details of the proc structure. The fields in the proc structure are:

The process id of the process.

A boolean indicating if the process has died.

A boolean indicating that this process structure belongs to the multiplexer. The multiplexer is treated differently.

A boolean indicating if the results of RPC calls are available.

Two boolean variables used for keeping track of the LECIS RPC interaction state.

The interaction handler that is being executed.

If the process structure describes an ICP process, this is the value of the UNIX domain socket via which RPC requests are sent and results read.

The current FSM (finite state machine) state.

The count of arguments in the parsed interaction.

The current interaction parsed into an argument vector.

The name of the process executing.

The interaction id that is used to uniquely identify a running process.

The result structure used to hold the result of an RPC request.

The fields in the structure have been described before.

A pointer to the next proc structure in the list or a NULL indicating the end.

Multiplexer Detail

After the multiplexer has created the server socket and read the first interaction of a LECIS RPC sequence, do_lecis( ) is called with the parsed interaction vector. Since this is the first time that do_lecis has been called, it initializes the multiplexer's proc structure and starts up the finite state machine to handle the rest of the RPC sequence.

There is a separate handler for each of the different types of interactions that can be received from the controller:

nextevent( ) which handles the NEXTEVENT interaction

ack( ) which handles the ACK interaction

run_op( ) which handles the RUN_OP interaction where most of the work is done.

run_op( ) copies the parsed interacton vector which constitutes part of the “contexf” of an RPC request into the process's proc structure, allocates space for the result that will be collected in getres( ) and calls do_call( ) to dispatch the RPC request.

do_call( ) checks an internal table to see if the call is internal (intended for the multiplexer) of external (must be passed to an ICP). Internal calls will finish by calling mkres( ) to fill the multiplexer's result structure which will later be returned by sndres( ) as an OP_RESULT interaction. External calls are handled by dispatch( ) which uses snd( ) to write the RPC request to the UNIX domain socket connecting the multiplexer and the ICP.snd( ) formats the RPC request to manner expected by the LRPC (LECIS RPC) library linked into each ICP.

The format is simply:

“function” “arg1” “arg2”. . . “argn”

Results for external calls will be collected asynchronously by getres( ) and returned by sndres( ). The most important internal function is run( ) which executes an ICP after it has been downloaded by download( ).run( ) creates a UNIX domain socket, calls fork to create a child process and then it executes

do_child( ) in the child process which redirects the child's stdin/stdout to point to the UNIX socket created in run( ), and

do_parent( ) in the original multiplexer process to create a new process structure, link it to the multiplexer's proc structure and fill it with initial values. After this has been done, the ICP is ready to field RPC requests.

ICPs and LRPC library

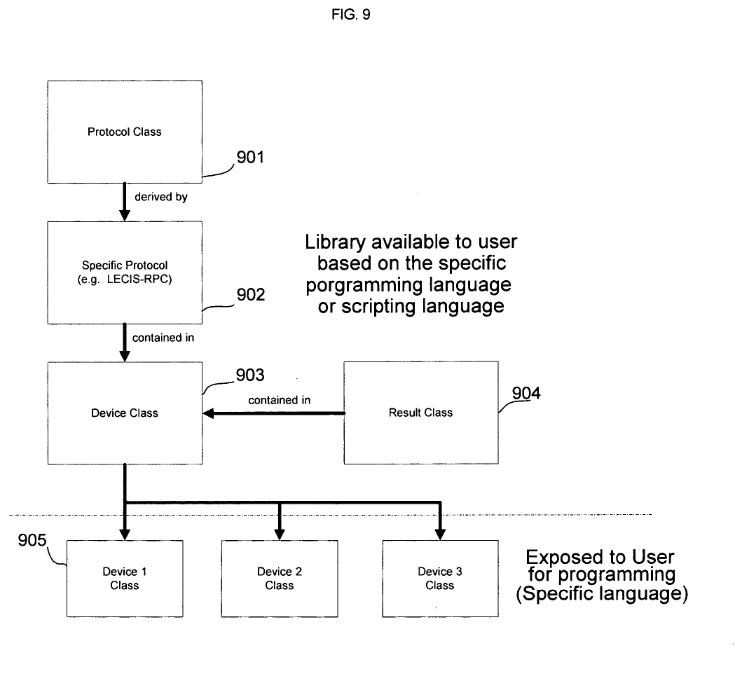

The ICPs and the LRPC (FIG. 9, Step 902) library are the remaining pieces in the ICL layer. Every ICP is linked with the LRPC library. The LRPC library is provided as an example implementation. Other libraries follow the similar schema for connectivity and data processing. The LRPC library provides a simplified communication interface to the multiplexer. The ICP writer provides functions that will be called by the LRPC library on RPC requests.

A skeleton ICP program looks like this:

#include <stdio.h>
#include “lrpc.h”
#include “skel.h”
int main (int argc, char* argv [])
{

lrpc_add_class (“init”);
lrpc_add_class (“process”);
lrpc_add_func (“set_device”, “init”, set_device);
lrpc_add_func (“init”, “init”, init);
dispatch ();

}
int set_device (int c, char* v [])
{

/*
* check the types and no. of args
* execute the rpc call.
* send RPC results using lrpc_send_result ();
*/
lrpc_send_result (TRUE, “”, “set_device done”);
return TRUE;

}
int init (int c, char* v [])
{

/*
* check the types and no. of args
* execute the rpc call.
* send RPC results using lrpc_send_result ();
*/
if (init_dev (device)) {
lrpc_send_result (TRUE, “”, “initialized device to normal parameters”);

return TRUE;

} else {
lrpc_send_result (FALSE, “”, “device init failed. reason = XXX”);

return FALSE;

}

}

The skeleton starts by including the header files it needs, then it includes the “lrpc.hh” header file to pick up prototypes for the Irpc_add_xxx( ) functions and dispatch( ). It then includes its own header files. main( ) starts out by adding some function classes. These function classes were introduced to group related functions (initialization functions, process related functions, real-time functions) together for the Process Manager tool. Some functions, for example, initialization functions like set_device( ) and init( ) must be called before any other functions can be run. The Process Manager or the Controller can make sure that all the functions in the init class are called before an instrument is used in a process. After adding the required classes (the init and info are mandatory), the skeleton adds functions to the classes defined, thereby registering these functions with the LRPC library. The arguments to lrpc_add_function ( ) are the function names exported to the outside world (basically a label), the class to which to the function should be added and the function that should be called when a RPC request for the exported function name arrives.

Calling dispatch( ) will block the ICP, waiting for RPC requests dispatch( ) which is implemented in the LRPC library reads from stdin and will call the functions registered as required. The RPC functions like set_device( ) or init( ) are passed an argument vector and the count of arguments in the vector like for main( ). Each RPC function is responsible for checking the number and types of the arguments it receives. After the RPC requests are processed, the results are sent back using lrpc_send_result( ), which takes the same three arguments referred earlier in the skeleton program.

The results are printed to stdout. This method of reading RPC requests from stdin and spitting results onto stdout allows the ICPs to be written and tested standalone.

Router Security

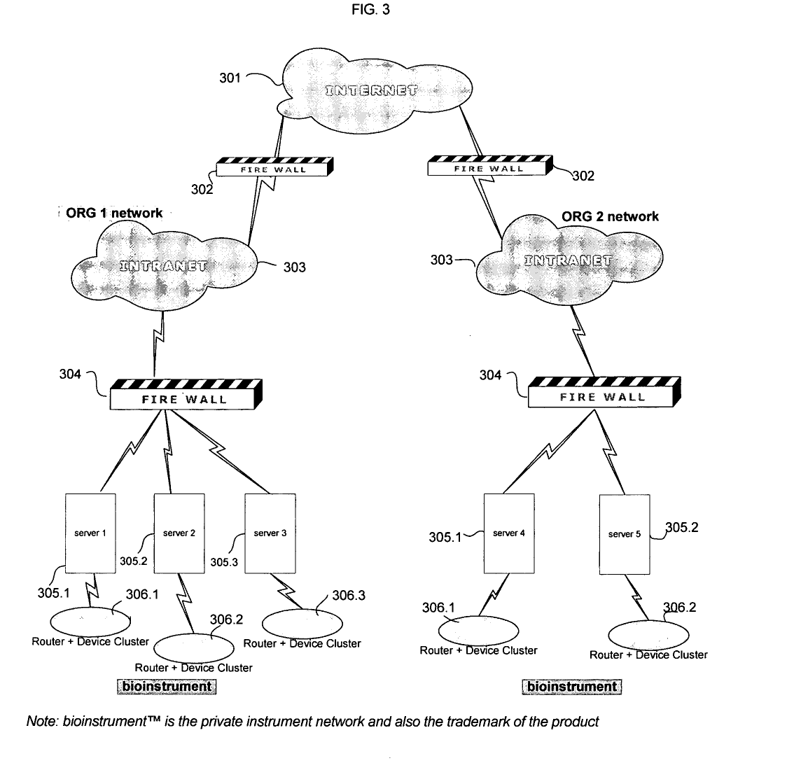

Since the communication between the Router and the Controller/Publisher may go through non-trusted networks, or via wireless infrastructure, all communication between the Router and Controller is encrypted. Each Router to Controller connection has a Secure Socket Layer (SSL) implementation (FIG. 2, Steps 209, 227, 214, 224 and FIG. 3, Steps 302, 304).

Router Implementation of a Secure Tunneling Scheme: ‘stunnel’

The ‘stunnel’ program is designed to work as SSL encryption wrapper between remote client and local (‘inetd’-startable) or remote server. The concept is that having non-SSL aware daemons running on the system can be easily setup to communicate with clients over the secure SSL channel.

stunnel will negotiate an SSL connection using the OpenSSL or SSLeay libraries. It calls the underlying crypto libraries, so stunnel supports whatever cryptographic algorithms were compiled into the crypto package in the Operating System.

stunnel supports standard SSL encryption with three levels of Authentication:

a: No peer certificate authentication

b: Peer certificate authentication

c: Peer certificate authentication with locally installed certs only

stunnel protects against

a: Interception of data by intermediate hosts

b: Manipulation of data by intermediate hosts

c: And additionally, if compiled with libwrap support:

IP source routing, where a host can pretend that an IP packet comes from another, trusted host.

DNS spoofing, where an attacker forges name server records

Controller Implementation

For RPC Interface, Router uses ‘stunnel’. The controller uses SSL Java language library. The cipher suite used between is ADH-RC4-MD5 with 1024 bit key encryption. Other cipher suites can be used if they are synchronized between the Router and the Controller layers. All the supported cipher suites enabled in the Java Security package are enabled. The SSL handshake protocol enables the most secure cipher suite available on both the Router and the Controller.

The file transfer is also secured using ‘sftp’ as the secured means of data transfer. The ‘sftp’ server is running on the Router side and the controller uses the sftp client.

Setting Up ‘Stunnel’ on the Router Side

1. generate the stunnel private key

a. generate Router key

openssl req-new-x509-days 365-nodes-config stunnel.cnf-out stunnel.pem-keyout stunnel.pem

b. generate Diffie-Hellman parameters, and appends them to the pem file [needed to sync with Controller side]

openssl gendh 1024>> stunnel.pem

c. protect the key

chmod 600 stunnel.pem

2. Launch stunnel

a. Standalone mode:

For testing purposes, stunner can be launched by the command line interface by giving the command stunnel-f-C ‘ADH-RC4-MD5’-d 1969-1 mux

b. inetd mode:

The stunner program is started by default through inetd dispatching mechanism which will launch the mux program on the Router.

Programming Language Independence for Creating Process Programs or Scripts.

FIG. 9 shows the details of the multiple programming language interface available to the user. When the users selects the Protocol Class(es) for Control and Data, the specific Protocol classes are derived from the Super Class. A library is built for each programming or scripting language (for example: C, C++, Java, Perl) and available within the system for the collection of programming and scripting langauges.

The user selects a programming or scripting language and creates a process ‘written’ in that language. The library for that particular language is used to compile the process program with compilation and editing tools that are available. This compiled process program is dispatched to the Routers by the Controller (descirbed below) and run within the Routers.

The monitoring and error processing layers can be graphical or a command line based interface.

The Controller

The controller is used for:

a: Converting process definition into communications protocol

b: Load balancing based on synchronized time (multiplexer)

c: Setting of actual parameters at execution time

Logical Data Flow Description (All numbers in parenthesis refer to FIG. 5):

1) After user authentication (Step 501), the user will use ProcessManager tool (Steps 502, 503) to create PREMI file (Step 504) and validate for its syntax.

2) Save the PREMI file through PREMI Language Introduction Layer (Step 503) to XML DB (Step 512).

3) All the ProcessManager created user files, device files, process files are saved into XML DB (Step 512) in an XML format.

4) To execute the process the user will use the ProcessMonitor Interface (Step 502).

5) The Instrument Control data (Step 505) will parse the PREMI file and controller layer (Step 504) will do the task scheduling to the Router through Remote Procedure Calls (RPC).

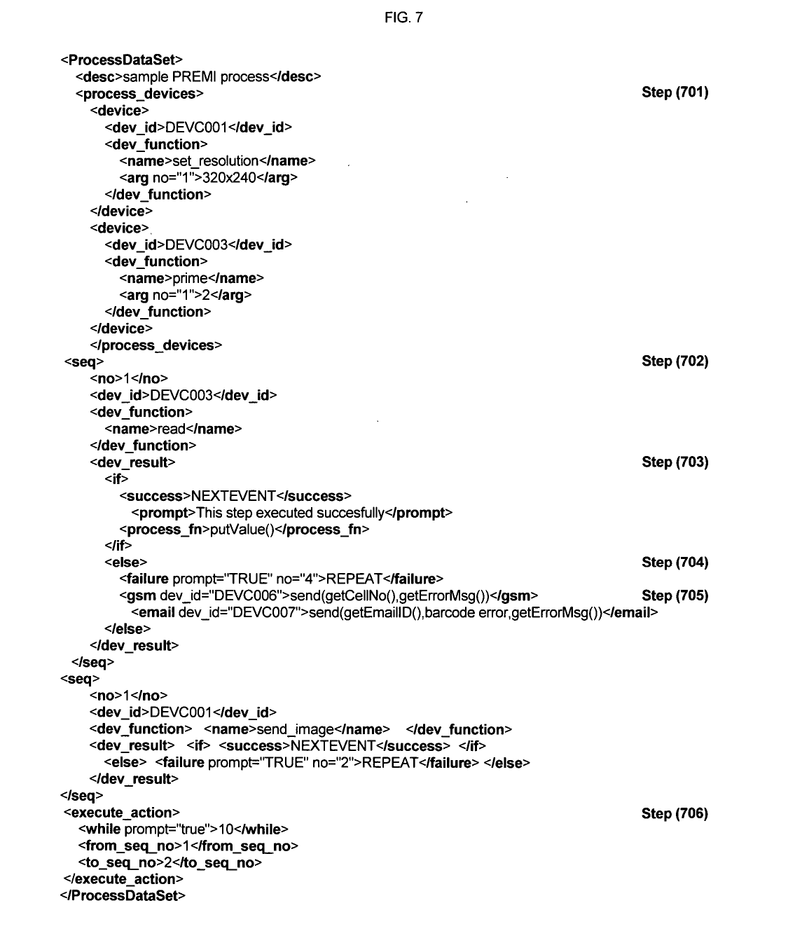

6) The communication between the RPCClient (Step 507) and RPCServer (Step 508) are in standard protocol (LECIS protocol formatting is illustrated in FIG. 7).

7) The Device Control Programs (Step 510) take care of the RPC calls and control the Devices/Instruments (Step 511).

8) The process result comes out from the Router (Steps 510, 509, 508, 507), that can be controlled by Controller layer (Step 506) and Instrument Control Data (Step 504).

9) All the process data are formatted into the XML database (DB) (Step 512). After a certain period the data from the internal XML DB can be archived or transferred to customer databases (Step 515).

10) Using DB Translation Layer (Step 513) the data is transformed into specific database formats (for example Oracle® database format, Postgres database format, Microsoft® SQL Server database format). (Step 515)

11) Using Data Translation Layer (Step 514) the data is translated into various data display formats (for example Adobe Portable Document Format, Microsoft Excel Format, Microsoft Word Format).

The Process Development Component

Process Manager Details

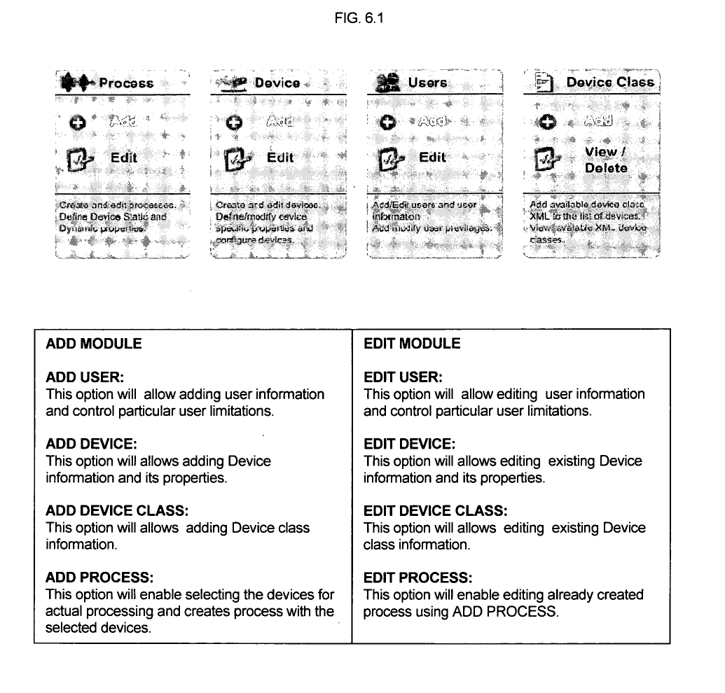

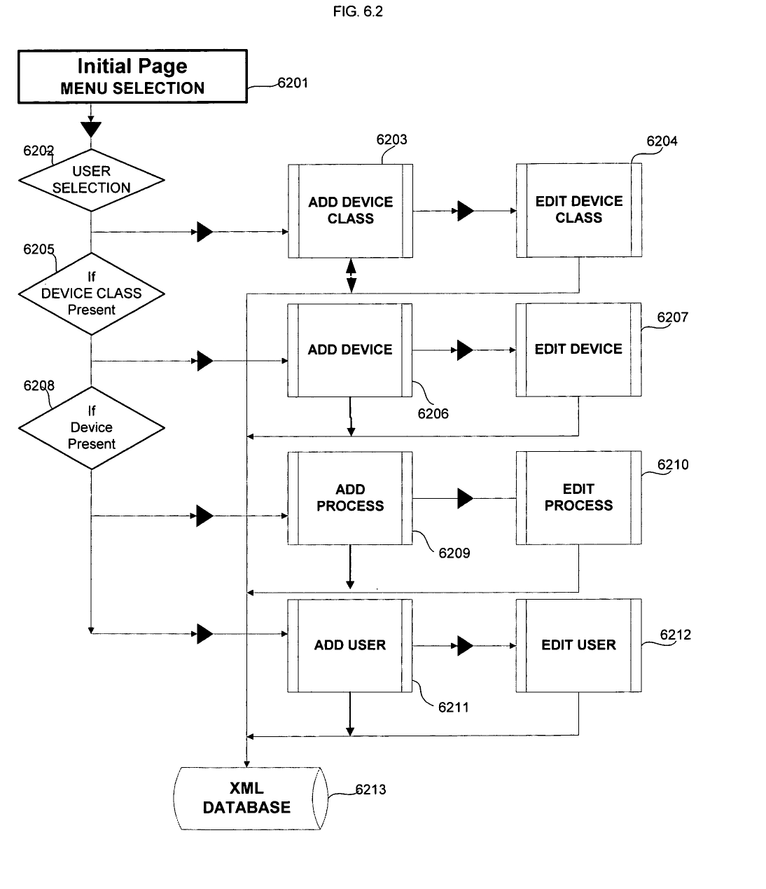

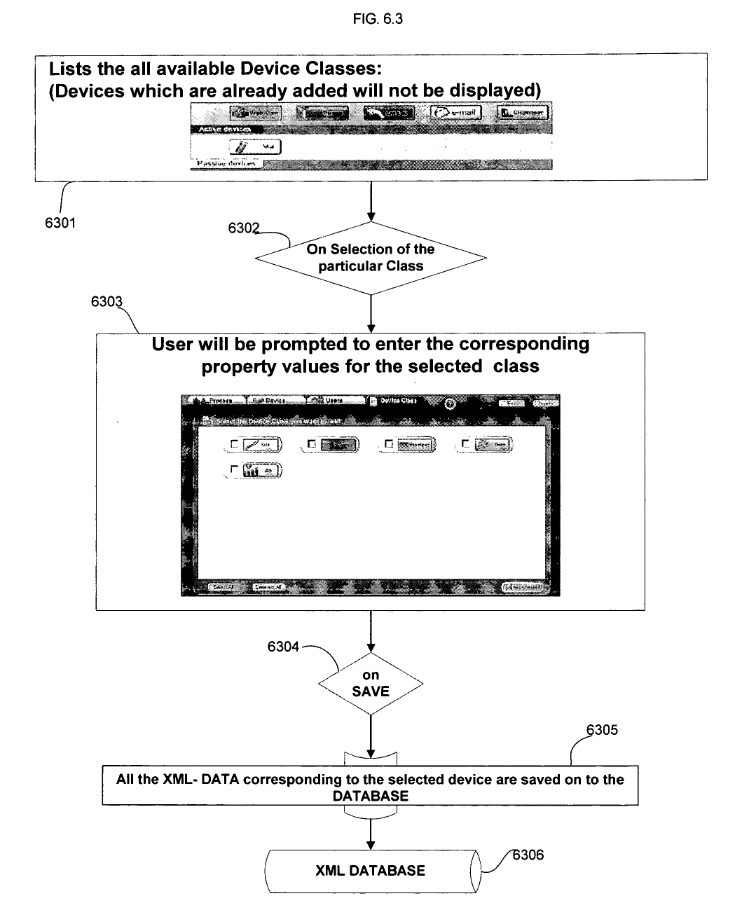

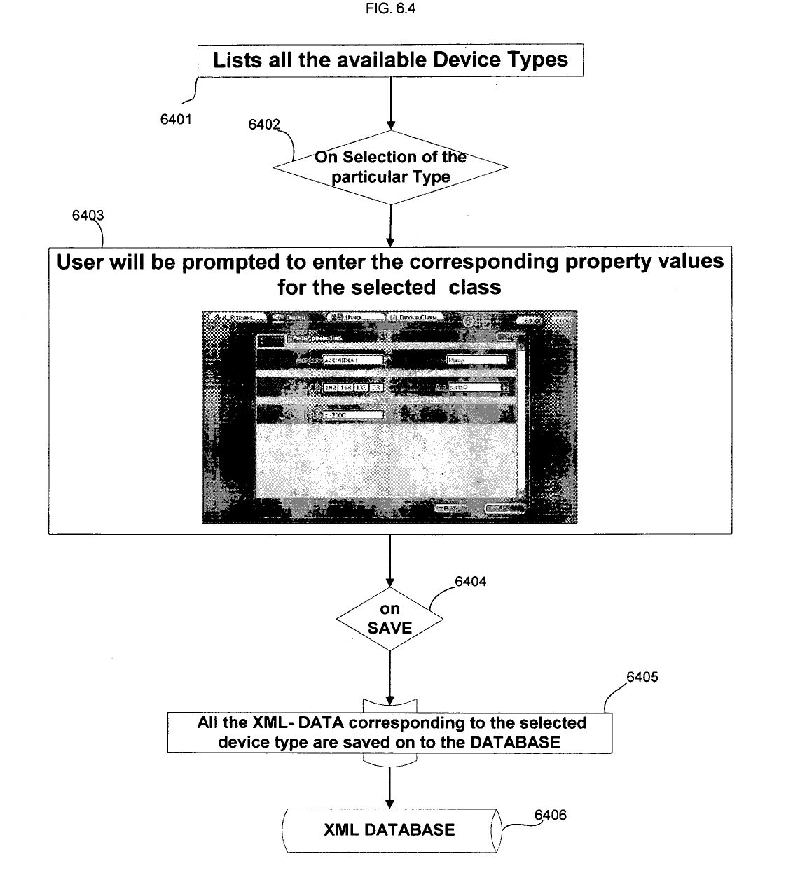

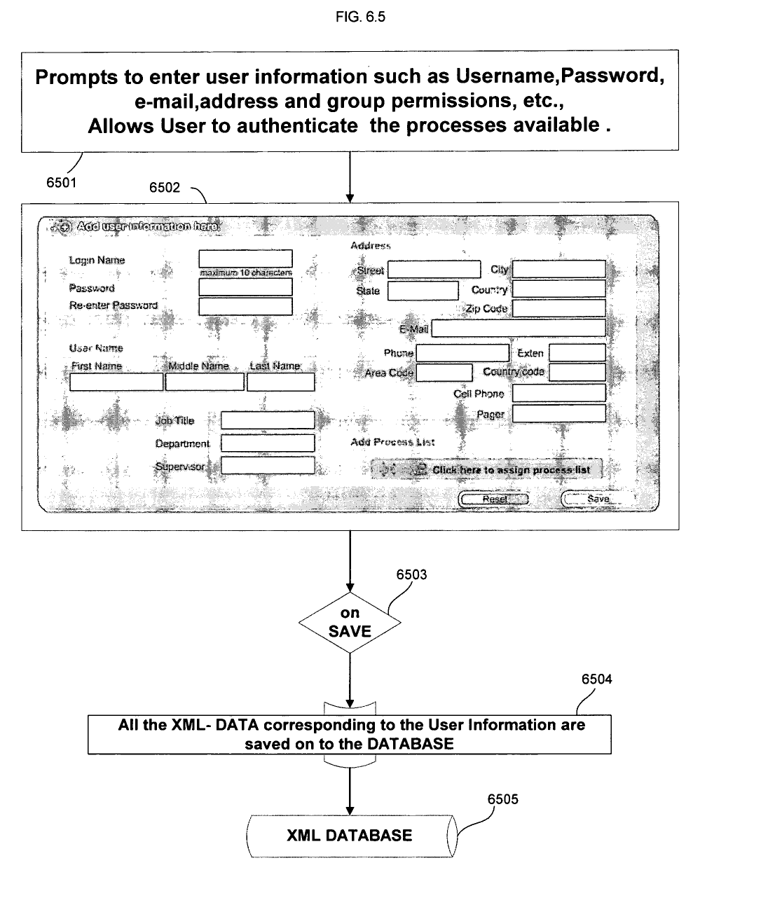

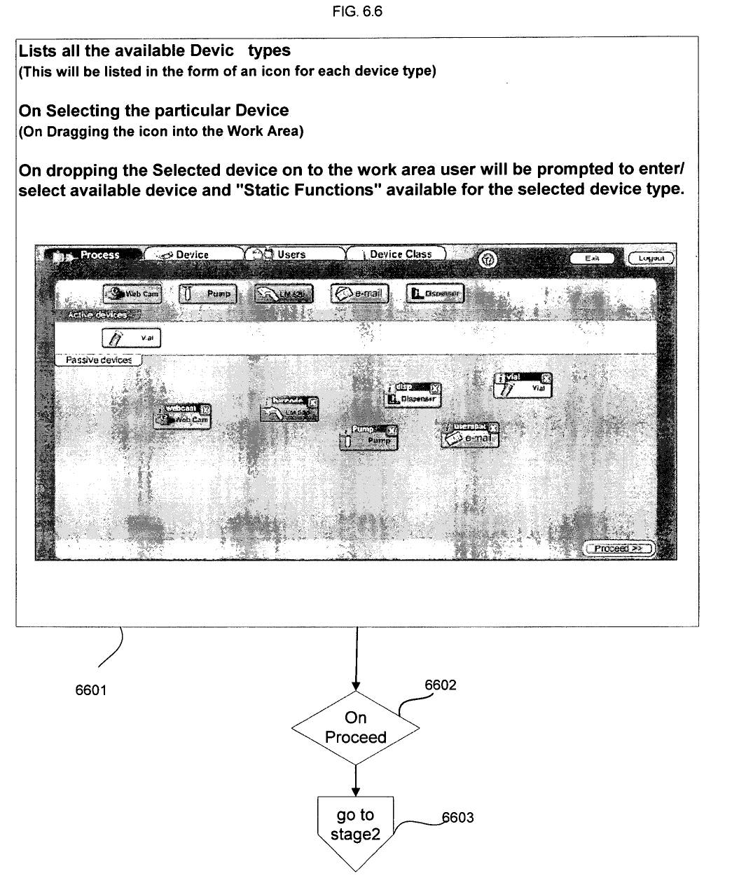

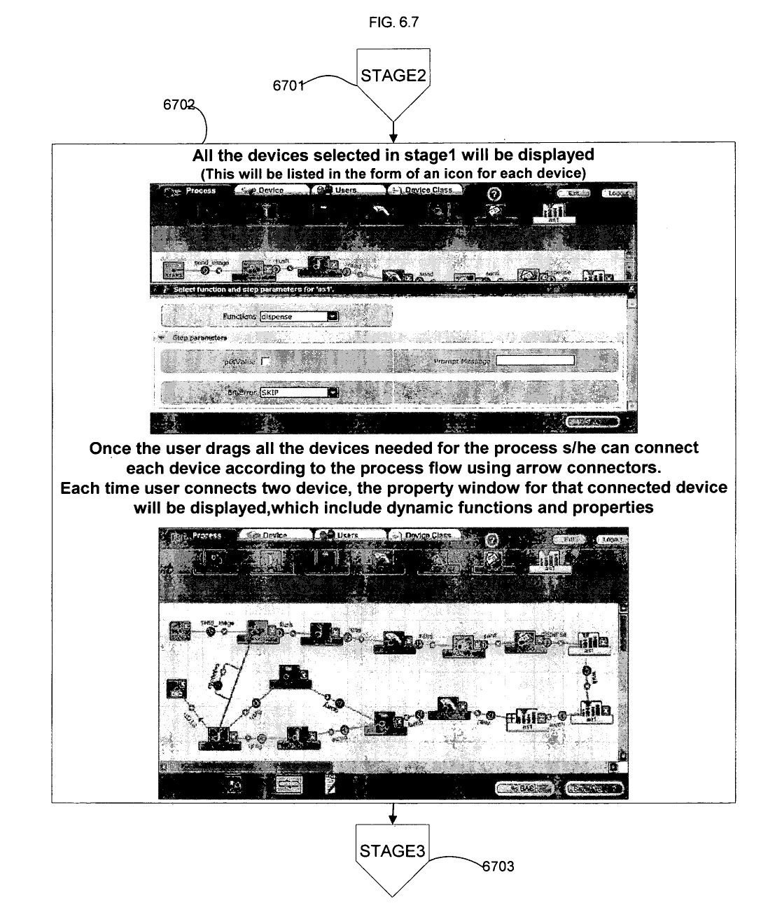

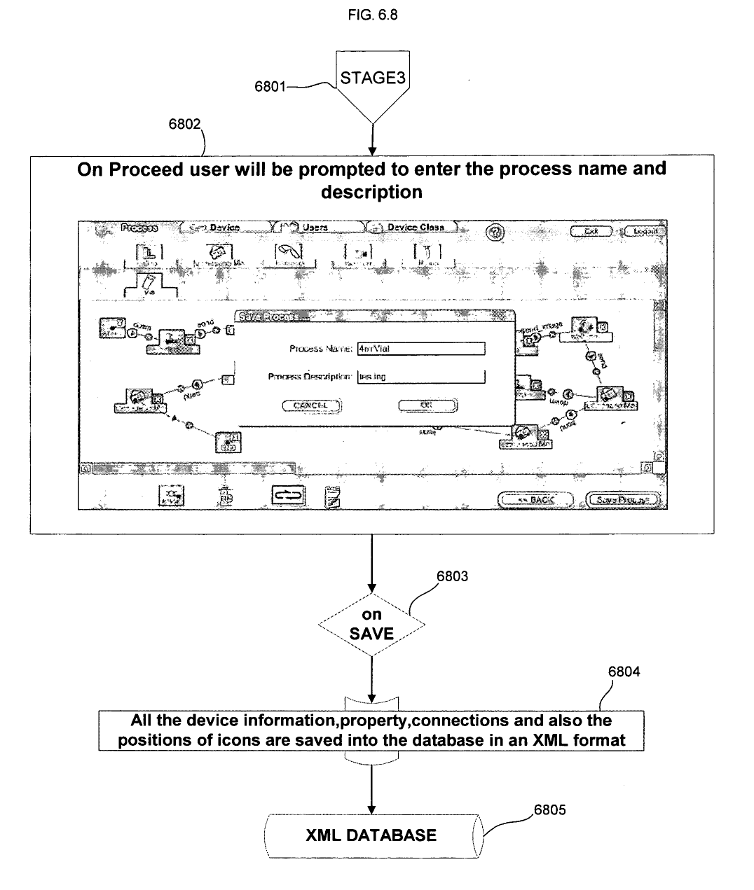

See FIGS. 6.1 to 6.8 for reference

Device Class Add/Edit

Device Class Add: This is the first step for any user to start with the Process Manager. The Device Class information needs to be entered before proceeding (FIG. 6.2, Step 6203).

The initial usage of he Device Class shows all the available abstracted device classes, which the user can choose and set the Device Class's static properties and dynamic properties (functions written on the RPC driver layer) with the arguments for those functions also enter the Device control file for a particular device type. On clicking “Save”, the Process Manager sends all the data to the server, which is stored in a XML database. This is to be done only once for each Device Type (FIG. 6.2, Step 6213).

Device Class Edit: Once user adds a Device Class, this information is available for editing. The user will get a list of Device Classes (FIG. 6.3, Step 6301), which has been added earlier. By selecting a particular Device Class (Step 6302) which s/he wants to edit, the user will get all the information stored for that Particular Device Class and s/he is allowed to make changes for all control information set like static functions, dynamic functions, arguments and the control file name (Step 6303).

Device Add/Edit

Device Add: Once the Device Class information is stored in the database (Step 6205), the user can configure a particular Router ip/port for a particular device class. The user will get a list of Device Class added to the database.

On selecting a particular Device Class user will get an option to enter the device name, its IP address, Port and Priority (Step 6403). Validation is provided to check whether that particular device Name/IP & Port has already been configured for a Router.

On clicking “Save” if the validation does passes the application will update the configuration in the XML database otherwise it will display a message to change the existing information.

Device Edit: Once the device is configured for a particular Router, it will be available for editing (step 6207). All devices configured will appear in the toolbar with a unique device identification label entered by the user. On dragging and dropping a particular device icon onto the work area, the tool retrieves the selected device's information from the server and displays it on the screen so that the user can make changes to the configuration.

Validation has been provided to check whether that particular device name/ip address and port has already been configured for a router.

On clicking save if the validation passes the application update the configuration in the XML database (Step 6406), If validation fails, the application displays a message to change the existing information.

The user can delete the device configuration provided it is not allocated to any currently stored processes.

Process Add/Edit

Process Add: This option helps the user define a process with already configured device and control information (Step 6208). The ‘drag-and-drop’ device feature shields the user from the complexity of the configuration of the device configuration/control information and helps the user to define a lab process easily and quickly.

Selecting the devices for the process is available on the first screen (Step 6601):

This screen is for selecting the Device Class and setting the static functions (initialization functions for the device) before executing the process.

The screen then displays all configured devices. The user has to ‘drag-and-drop’ the Device Class icon to the work area to set the static functions for the device. Once the icon is dropped into the work area, property window appears on the right side wherein the user can set the device name, static functions and arguments for those functions.

If the user wishes to delete a particular device after dragging to the work area., s/he can do so by merely clicking on the close icon on the top right corner of the device class icon. After he has selected all the devices and set the initialization functions the user can click “Create” (Step 6602).

Creating the process graphically is available once the devices in the processes are selected: This screen is for setting the dynamic functions and process sequence, which will be executed after the initialization functions, are completed in a process (Step 6702).

The screen then displays all the devices, which s/he has added, in the previous screen.

The user must ‘drag-and-drop’ the device icon to the work area to set the process steps, dynamic functions and arguments for those functions.

After dragging the icons which user wants to include in that particular process, the user can connect the devices together. After the two device icons are connected, the property window appears, where the user has to set the dynamic functions and arguments for that function (which will be executed when the process is running). The user will have a option to set “on success” or “on error” for that particular step what action he wants to perform at that point in the process execution (if that step is an “on error” step the user can set the repeat function on error and no of times to repeat that step before notifying the user again). Each two device icons connected by a function constitutes a granular “step” in the process.

E-mail and GSM can be added to particular steps and the user can set options to receive a message on either successful or unsuccessful execution of a particular process step or both to that user's cell phone number and email ID (Step 6702 lower screen).

The user needs to add “Start” icon in the beginning of the process and an “End” icon to the end of the process. Before saving the process, the user can make changes to the process like deleting devices, adding new devices and resetting the process flow (Step 6802).

On clicking “Proceed”, a dialog box appears to enter the process name and description. On clicking “Save” Process manager sends the name to server for validation (Step 6803). If the process name is unique, the application sends the PREMI XML file generated to the server which is updated in an XML database (Step 6805).

Process Edit: All created processes will be available for editing.

The screen shows all available processes for that user, which can be selected (by dragging a particular process icon to work area) for editing. To delete a process that is not allocated to any user, the user can ‘drag-and-drop’ that process icon to the trash bin and that process information is deleted from the database. If a process is allocated to several users, the application presents the user list.

On selecting a particular process for edit, the Process Manager gets all the process information from the XML database.

The Process Edit screen follows the same logic as the process add screen steps, where the devices selected for the process are shown:

According to the selected process in the first screen, the Process Manager displays the icons in the work area for which user can make changes (static function and arguments) or delete a particular device. When the user selects particular device for editing, in the property window already selected function and device name are displayed so that the user can make changes. The user can drag and drop device class icons from the toolbar and set the initialization functions again.

Once the devices selected are added, deleted or edited, the second screen of the process allows the user to edit the actual process flow:

Here the process image with the flow of the already saved process is displayed.

The user will have all options to make changes or s/he can delete particular steps and add different devices or change the dynamic functions. The user can also add E-mail and GSM for any step or device. All features available during the creation of the process are available during process editing.

On clicking “Proceed” the application displays the current process name, which can be changed. This is saved in the XML database on the server in the PREMI XML Document Type Definition (DTD) format.

User Add/Edit

User Add: In this option the administrative (‘admin’) user can add a user list to the database. The user can also assign process to a particular user (Step 6502).

By dragging a new user icon to work area the admin user will receive the option to enter all user information, starting with the login name and password. Other user information is also entered like Name, Address, Phone numbers, e-mail, and other process related information like groups and permissions for specific devices. Validation is done for already allocated login Id.

If the user's login identifier already exists, the user has to change the login name. The entered information is saved in a XML database on the server (Steps 6504, 6505).

User Edit: In this option the admin user can edit user information and make changes to assigned process(es) to a particular user. The admin user can also delete a particular user.

The admin user will see all available user icons. To edit them s/he has to ‘drag-and-drop’ that icon to the work area. For deleting s/he has to drop that icon to the trash bin. Then the admin user can make changes to the existing user information and save the changes in the XML database (Step 6505)

The Process Definition Format

XML format and code (see FIG. 7)

Preprocess Steps: (step 701)

The pre-process information is stored inside the parent tag <process_devices/>.

The devices used by the process are stored in its child node <device/>.

The static pre-process functions with arguments are specified inside <dev_function/>

Process Steps: (Step 702)

Sequential process steps are assigned with different unique sequence numbers and the parallel process steps come under common sequence numbers. The <seq> tag contains the sequence number.

The dynamic process functions with arguments are specified in its child node <dev_function/>

Error Handling Steps: (step 704)

The error handling information is stored inside <dev_rersult><if><else><failure>

Using the “no” attribute the user can repeat the same step ‘n’ number of times.

Using the “prompt” attribute the user can display or hide the error message or display it in the GUI and ask for user input. By using the ‘STOP’ tag the user can stop the process.

Onsuccess Steps: (step 703)

The onsuccess information is stored inside <dev_rersult><if><success>.

The user can go to the next step by saying ‘NEXTEVENT’ tag and stop the process by using the ‘STOP’ value.

The user can display any message during the process run by using the <prompt> tag.

The user can view the data from the device(s) by using the <process_fn> tag.

Messaging Steps: (step 705)

Using this method with the “on success” and/or “on error” the user can communicate with the process using handheld devices. For example:

<gsm>send(cellNumber,errorMsg)</gsm>

<email>send(emailID,subject,errorMsg)</email>

Loop Steps: (step 706)

The loop information is stored in the <execute_action> tag.

Using <while> the user can define the number of times s/he want to execute the process from (<from>) step to the (<to >) step.

Function Description:

| | |
|---|---|
| getValue() | get the value from a temporary buffer |
| putValue() | put the process onsuccess raw data output into a |
| | temporary buffer. |
| getEmailID() | get the email id from the user file or from dynamic input. |
| getCellNo() | get the cell number from the user file or from dynamic |
| | input. |
| getErrorMsg() | get the process onerror raw data output. |
| send() | To send messages to handheld devices. |

The Monitoring Component

The Monitoring component is a web browser based application that is sent to the user upon authentication.

The monitoring component has the following display components:

process diagram during execution results of each step during display of process diagram

physical location of instruments

errors with the step(s) the error occurred

possible decision points for user to intervene and make a decision on

charts and figures either of the data stream or that is complied from data

From the foregoing, it will be appreciated that specific embodiments of the invention, with examples illustrating the standard protocols, have been described in detail for purposes of illustration, but that various modifications may be made without deviating from the spirit and scope of the invention. Accordingly, the invention is not limited except as by the appended claims.

We claim:

1. An embedded computer method and process (the ‘router’) for controlling and monitoring various devices and instruments wherein:
a. The control and/or the data communications protocol is chosen by the user of the process from an available list either locally or remotely over a network
b. These control and/or data communications protocols are implemented by the embedded computer method either locally or remotely over a network as specific control commands within the system for the devices and instruments, whose return results are interpreted into data that is captured within the system process format
c. These instrument commands have standard names for device or instrument functionality across different manufacturers
d. Algorithmic processing can be applied on the control information and data interpretation as part of the instrument or device process which can happen in real-time to the user interface as a set of numeric values or a chart or image or can be stored for subsequent conditional or repetitive processing
e. The process definition can be made using graphical programming which is interpreted as the operational sequences in the embedded computer method, or using programming and scripting languages (for example: C, C++, C#, Java, Perl, Python).
f. The raw and processed data is available for storage or archival within various databases

2. A method as described in claim 1 where a private secure network is used to control the instruments, and where the client user interface allows authenticated users to connect to the devices and instruments.

3. A method as described in claim 1 where multiple embedded computers can communicate the process status and data and make decisions on the instruments that are connected to that embedded computer.

4. A method as described in claim 1 where the error communication from the instrument and from the process is available to the user and the process either locally or remotely over a network, which can act upon the process either directly or by human intervention of the error.

5. A method as where multiple embedded computers connected to devices or instruments can run the commands and data processing for one or more process in parallel.

6. A method where the multiple embedded computers (‘routers’) connected to devices or instruments can reside in a secure private network where the control and data are encrypted.

7. A method where device or instrument information in the process is available directly to the user interface using standard protocols.
